(19) United States
(12) Patent Application Publication
(10) Pub. No.: US 2006/0248763 A1
(43) Pub. Date: Nov. 9, 2006

(54) Beverage delivery truck with signage device for selectively displayed messages

(76) Inventor: Robert M. Tarabella, Fairhope, AL (US)

Correspondence Address: BAKER, DONELSON, BEARMAN, CALDWELL & BERKOWITZ, SUITE 3100 SIX CONCOURSE PARKWAY, ATLANTA, GA, 30328, US

(21) Appl. No.: 11/125,005

(22) Filed: May 9, 2005

(51) Int. Cl. G09F 21/04

(52) U.S. Cl. 40/590; 40/591

(57) ABSTRACT

A beverage delivery vehicle with a plurality of lateral side-accessible bays for transport of beverages and having a back wall to which a signage device attaches and having a plurality of discrete signage messages for selective display during travel of the beverage delivery truck. A method of display of signage messages during travel of a beverage delivery vehicle is disclosed.

### TECHNICAL FIELD

The present invention relates to mobile advertising signs. More particularly, the present invention relates to beverage delivery trucks configured with signage devices for selective display of advertising signs and messages.

### BACKGROUND OF THE INVENTION

Advertising communicates goods and services available from manufacturers and retailers for sale to customers. Advertising takes many forms including print, radio, television, and signage, among other advertising mediums. One important consideration for effective advertising is the number of impressions the advertisement makes on perspective customers. The higher the number of impressions, the more exposure perspective customers have to the advertised goods or services, and thus the greater the opportunity to sell the goods or services.

Billboard signage provides large graphical displays observable by perspective customers over great distances. Typically, billboards are stationary and are placed along highways and roads that have a high amount of traffic. The effectiveness of the advertisement on the billboard however lessens over time as passersby become more familiar with the content of the message displayed on the billboard.

To maintain freshness and spontaneity, sign technology has become more active. In particular, a sign mechanism provides a cabinet that encloses a number of parallel rotatable panel assemblies. The panel assemblies connect to gear assemblies on one side of the cabinet. A motor drives the gear assemblies through a drive shaft. Each panel assembly includes three sign panels. The panels assembly accordingly defines a triangular rotatable member in cross-sectional view. The panels are correlated so that a first one of the panels in each assembly includes a portion of an advertisement. Similarly, the second of the panels on each shaft includes a portion of a second advertisement. And likewise for the third panel.

In use, the panels for one advertisement are displayed outwardly of the cabinet. Periodically, the motor operates to rotate the drive shaft and gear assemblies to cause the second set of panels to rotate and appear outwardly of the cabinet. This presents the second advertisement for observation. This cycle repeats periodically for each set of panel assemblies in succession. Accordingly, a single billboard can provide several varied messages or advertisements.

However locations for fixed position billboards present problems as well. Sign ordinances may limit visible locations and plant growth such as trees, vines, and the like, may interfere with visibility.

Another mechanism to increase the number of impressions for a billboard sign is the development of mobile billboards. Flatbed trucks are equipped with a large billboard frame which contains advertisements on opposing sides. The flatbed truck is then driven through communities and along various roads and highways. This increases the visibility of the sign by bringing the billboard advertising to the perspective customers. In addition to flatbed trucks, some trucks are equipped with trailers for pulling billboard signs as well as mounting the cabinets described above that hold the rotatable panels.

While such signage vehicles have increased the visibility of advertising signage, there are drawbacks to their use, including the need for a specialized vehicle lacking other purposes for occupying a roadway and attendant labor costs for operation of the vehicle.

Accordingly, there is a need in the art for a motor vehicle with a signage device for selective display of messages. It is to such that the present invention is directed.

### SUMMARY OF THE INVENTION

The present invention meets the needs in the art by providing a signage device that mounts to a back of a beverage delivery truck for selective display of a plurality of signage messages during travel of the beverage delivery truck.

In another aspect, the present invention provides a method of providing a display of an advertising message for an advertiser, comprising the steps of:

(a) attaching a signage device to a back wall of a beverage delivery vehicle having a plurality of lateral side-accessible bays for transport of beverages;

(b) providing a plurality of discrete signage messages for selective display by the signage device, each signage message associated with an advertiser;

(c) operating the signage device for display of the signage messages during operation of the beverage delivery vehicle for delivery of beverages.

Features and advantages of the present invention will become apparent upon a reading of the following detailed description in conjunction with the drawings and the appended claims.

### BRIEF DESCRIPTION OF THE DRAWINGS

FIG. 1 is a rear right perspective view of a beverage delivery truck equipped with a selectively displayed signage device in accordance with the present invention.

FIG. 2A is a detailed plan view of a cabinet sign that mounts to the beverage delivery truck illustrated in FIG. 1.

FIG. 2B is a right side view of the cabinet sign illustrated in FIG. 2A.

FIG. 2C is a left side view of the cabinet sign illustrated in FIG. 2A.

FIG. 2D is a top plan view of the cabinet sign illustrated in FIG. 2A.

FIG. 3 is a back view of a beverage delivery truck illustrating an embodiment of the cabinet sign shown in FIG. 2A changing from display of a first sign to a second sign.

FIG. 4 is a back view of an alternate embodiment of a beverage delivery truck in which the signage device is an electronic image display screen.

FIG. 5 is a back view of an alternate embodiment of a beverage delivery truck in which the signage device includes a scrollable panel carrying a plurality of messages for selective display.

### DETAILED DESCRIPTION

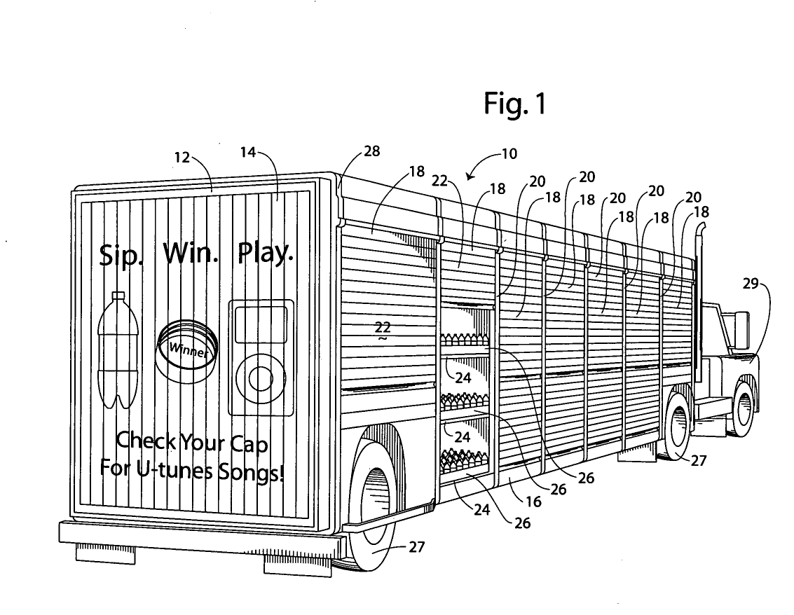

Referring now in more detail to the drawings, in which like reference numerals indicate like parts, FIG. 1 illustrates in perspective view a beverage delivery truck 10 having a signage device 12 that selectively presents one message generally 14 of a plurality of signs or messages, according to the present invention.

The beverage delivery truck 10 has a body 16 that is subdivided into a number of bays 18 by a central longitudinal wall extending in a lengthwise direction and by bay partition walls 20 that extend laterally from the central longitudinal wall. Bay doors 22 are provided in the side walls of the vehicle body 16 for providing exterior access to the bays and for closing the bay to access during transport of goods. The bays 18 include a plurality of shelves 24 that receive containers 26 typically of beverages for transport from a drink manufacturer or warehouse to a sales facility. The beverage delivery truck 10 includes wheels 27 for mobility by a conventional tractor rig 29. The beverage delivery truck 10 accordingly provides side-accessible bays 18 for containing goods, e.g., beverage containers, for delivery, while a back wall 28 closes the body 16.

In accordance with the present invention, the signage device 12 mounts to the back wall 28. The signage device 12 is of a type that displays one sign 14 of the plurality of signs, selectively in a sequence and for a selective period of time, so that as the beverage truck 10 moves along roads and highways during its delivery schedule, the various signs or messages of the plurality of signs are displayed selectively for viewing by persons in the vicinity of the beverage delivery truck.

In the illustrated embodiment, the signage device 12 comprises a cabinet sign 30 (discussed below) that mounts to the back wall 28 with fasteners, such as nuts and bolts connecting a frame of the cabinet sign 30 to the back wall or to backing plates disposed on an opposing side of the back wall with in the rearmost bay 18 of the body 16.

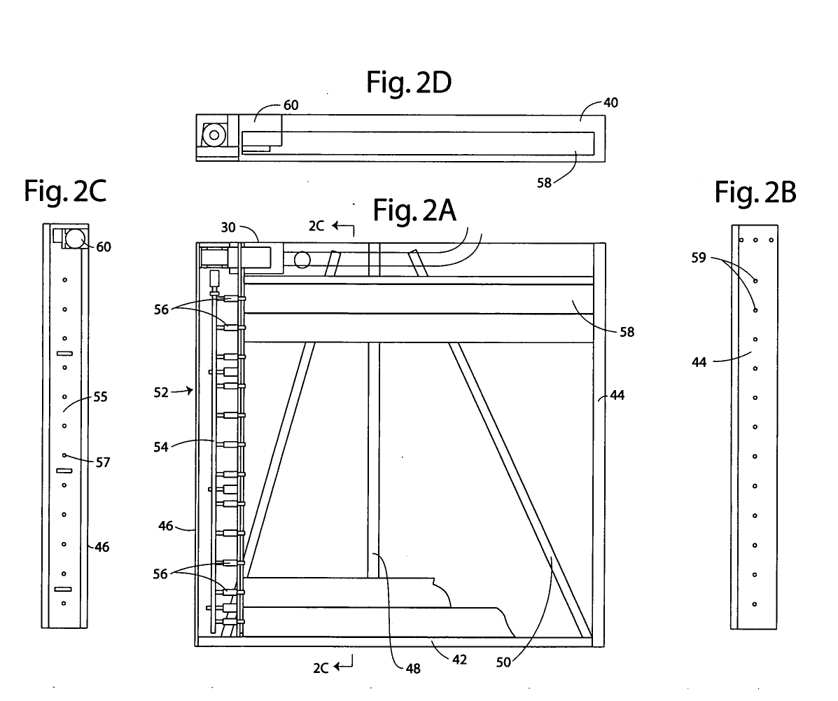

FIG. 2A is a front plan view of the cabinet sign 14 with a right side view shown in FIG. 2B, a left side view in FIG. 2C, and a top plan view in FIG. 2D. The cabinet sign 30 has a frame made of opposing bottom and top rails 40, 42 and side members 44, 46. A center member 48 extends between the top and bottom rails 40, 42. Diagonal members 50 extend at an oblique angle relative to the center member between the top and bottom rails. A gear drive assembly 52 includes a drive shaft 54 and laterally disposed gear trains generally 56 disposed in spaced-apart relation and held by a support member 55 with pins 57. Each gear train 56 connects to a sign panel assembly 58. The sign panel assembly 58 is rotatably supported by the side member 44 with pivot pins 59 and is operatively engaged to the particular gear train 56.

The sign panel assembly 58 includes a plurality of panels 62 disposed angularly relative to each other, e.g., three panels define a triangle in end view; four panels define a rectangle in end view. Each panel 62 includes a portion of a particular sign. A complete image or sign is defined by a set 63 of one panel 62 from each of the sign assemblies. The panels 62 are associated so that a first panel in each sign assembly 58 contains a portion of the complete image of the particular sign 14, while a second one of the panels 62 contains a portion of the complete image of a second particular sign, and likewise for the other of the panels in the sign assemblies 58.

The shaft 54 connects to a motor 60. Rotation of the shaft 54 causes the sign assemblies to rotate and thereby display the next one of the signs 14. The motor 60 operatively connects to a control box (not illustrated) with wiring. The motor 60 operates by a battery or by wired electrical connection with the engine of the tractor rig 29. The cabinet sign of a type useful with the present invention is available from Ad-Tech International, Inc., Atlanta, Ga.

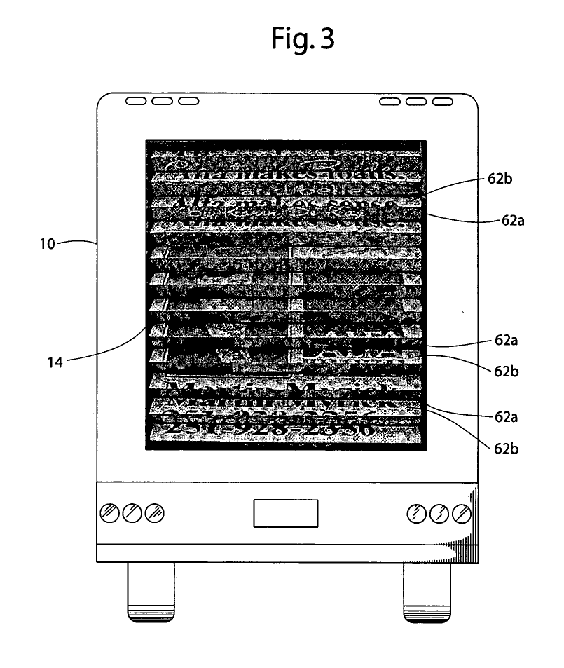

FIG. 3 illustrates a rearview of the panel truck 10 having an alternate embodiment of the cabinet sign in which the sign assemblies are disposed horizontally relative to a road surface rather than vertically as illustrated in FIG. 1. The cabinet sign 12 is illustrated changing the displayed sign 14 changing from a first sign or advertising image to a second sign by the rotation of the sign assemblies to move panels 62a from view and move panels 62b into view for display of another sign. As discussed above, the panels 62 in the sign assemblies 58 are associated with a respective one of the plurality of signs so that the panels 62a in each sign assembly 58 are displayed simultaneously for presentation of the complete image of a particular sign, and likewise for the associated panels 62b for a second sign and for the subsequent associated panels in the sign assemblies.

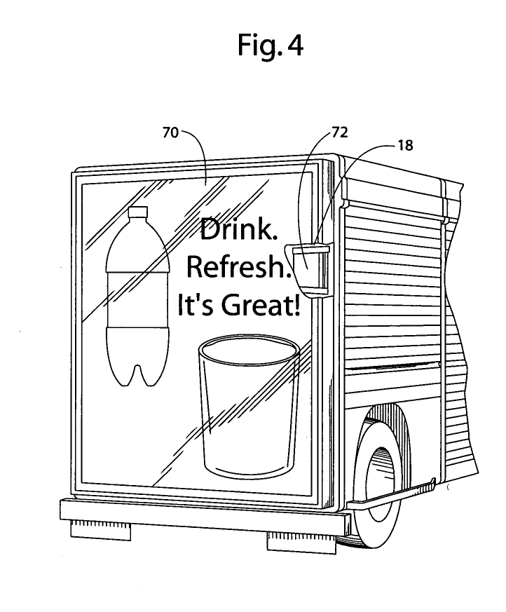

FIG. 4 is a back view of an alternate embodiment of a beverage delivery truck in which the signage device 12 is an electronic image display screen 70. A controller 72 illustrated in cut-away view mounts within the truck, for example, in a rearward one of the bays 18. The controller 72 is a conventional microprocessor device adapted for operational control of the display screen 70, and includes a memory device that holds electronic signals representative of the plurality of signage messages. The controller 72 is operative with computer software for selective display of the signage messages on the display screen 70. An LED electronic display is useful for video or fixed image displays while an LCD or plasma display is particularly useful at night. Sign images can be communicated to the controller directly by wired connection of a communicator with a sign-defining computer system, by wireless communication, or other conventional communication means for providing electronic data to a memory device of a microprocessor device.

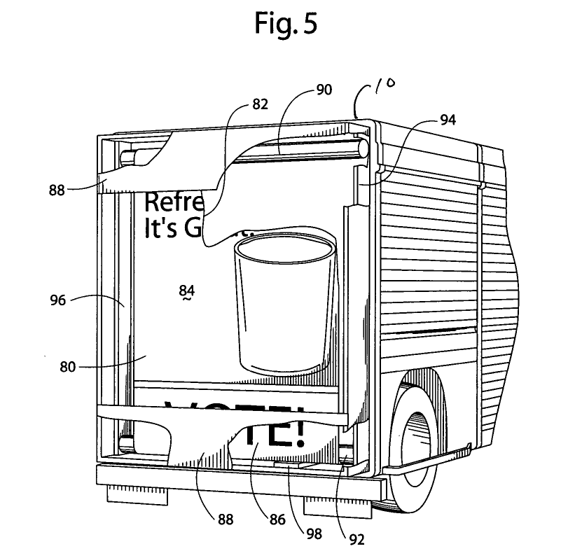

FIG. 5 illustrates a back cut-away view of yet another an alternate embodiment of a beverage delivery truck 10 having a signage device 80 attached to the back plate. The signage device 80 includes a scrollable panel 82 carrying a plurality of messages 84, 86 for selective display within a frame 88 (partially illustrated in cut-away view). The signage device 80 includes a driven roller 90 and an idler roller 92 disposed in spaced-apart relation. In the illustrated embodiment, the scrollable panel 82 is an endless belt received on the driven roller 90 and the idler roller 92. Tension adjusters enable moving the rollers 90, 92 relatively apart to provide operational tension on the panel 82. The ends of the rollers 90, 92 are supported in bearing blocks attached to support members 94, 96 of the signage device 80. The driven roller 90 connects to a motor for rotation of the roller. A controller operatively connects to the motor for selective rotation of the driven roller 90. The controller advances the panel 82 for sequential display of the signs or messages on the panel. The advertiser can select the duration of display, and the controller stops and starts the roller 90 to advance the image or sign being displayed.

FIG. 5 also illustrates a location tracking device 98 of a type commonly referred to a GPS unit. The tracking device 98 receives satellite signals by which the tracking device determines the geographic location of the beverage delivery vehicle. The route of the beverage delivery truck can thereby be tracked, so that estimates of impressions or observations by persons can made and reported to advertisers. The location tracking device 98 is usable with the other display devices illustrated in FIGS. 1 and 4.

With continued reference to FIG. 5, in an alternate embodiment, both rollers 90, 92 are selectively rotatable by a motor (during which the other roller operates as an idler), and the scrollable panel is an elongate panel fixed at distal ends to the rollers. The panel is driven in a first direction by one of the rollers for selective display of all of the signs or messages and after display of a last message, the controller reverses the direction of movement. The second roller is then driven to bring the messages selectively into view. The movement and reversal of the panel is repeated by a controller. In one aspect, the controller times the display of the messages depending on the agreed-to terms of the advertising display. One of the messages can thus be displayed for a first period while another of the messages is displayed for a second period longer than the first period.

With reference to FIGS. 1 and 3, during operation of the beverage delivery truck 10 travels a route for delivery of beverages. During operation of the beverage delivery truck 10, the signage device 12 operates to selectively display sign images 14. The controller selectively and periodically operates the motor 60 to rotate the shaft 54 and thereby cause the sign assemblies 58 to rotate. This moves the panels 62 of one sign from display and view and moves the panels of a second sign into view for display. In the alternate embodiment illustrated in FIG. 4, the controller directs the screen 70 to replace the display of one sign with the display of another of the signs. In the embodiment illustrated in FIG. 5, the controller causes the driven roller 90 to rotate, and thereby move the panel 82 relative to the idler roller 92, to bring signs or images into display sequentially.

In on aspect of the present invention, an advertising agency provides and maintains the signage devices that are attached to beverage delivery trucks for a beverage manufacturing and distribution company. The advertising agency solicits advertising from others, generates the graphic images and text for display, interacts with the beverage company for installation of the signage panels on the display devices of the beverage delivery vehicles, attends to payments from the advertisers, in exchange for consideration paid to the owner of the beverage delivery vehicles. The controller operating the signage device maintains records reflecting an identifier designating each of the signs or messages for display, the date and time of display, and the duration of the display. The tracking device 98 further indicates the location of the beverage delivery vehicle during display of the sign or message. The total display duration can also be determined and reported to the advertiser for compliance and impression observation purposes.

The present invention accordingly provides messaging and signage display by the mobile beverage delivery truck with the signage device that selectively displays the messages and signs during travel throughout delivery areas, with a method for presentation of signage message displayed on a signage device attached to a back wall of a beverage delivery truck. The principles, preferred embodiments, and modes of operation of the present invention have been described in the foregoing specification. The invention is not to be construed as limited to the particular forms disclosed as these are regarded as illustrative rather than restrictive. Moreover, variations and changes may be made by those skilled in the art without departing from the spirit of the invention described in the following claims.

What is claimed is:

1. A beverage delivery vehicle with a plurality of lateral side-accessible bays for transport of beverages and having a back wall, the improvement comprising a signage device attached to the back wall and having a plurality of discrete signage messages for selective display.

2. The beverage delivery vehicle as recited in claim 1, wherein the signage device houses a plurality of rotatable signage assemblies each having a plurality of sign panels, with each sign panel defining a portion of a one of the plurality of signage messages, and means for displaying simultaneously the sign panels associated with the same one of the plurality of signage messages.

3. The beverage delivery vehicle as recited in claim 1, wherein the signage device is an electronic image display screen and further comprising an electronic controller having a memory for holding electronic signals representative of the plurality of signage messages and operative for selective display of the signage messages on the display screen.

4. The beverage delivery vehicle as recited in claim 1, wherein the signage device includes a pair of opposing rollers that receive a panel bearing images for display, at least one of the rollers selectively operative by a driver device to advance the panel for display of the images carried on the panel.

5. The beverage delivery vehicle as recited in claim 4, wherein the panel is an endless belt.

6. A method of providing a display of an advertising message for a plurality of advertisers, comprising the steps of:
(a) attaching a signage device to a back wall of a beverage delivery vehicle having a plurality of lateral side-accessible bays for transport of beverages;
(b) providing a plurality of discrete signage messages for selective display by the signage device;
(c) operating the signage device for display of the signage messages during operation of the beverage delivery vehicle for delivery of beverages.

7. The method as recited in claim 6, wherein the step (b) comprises the step of providing an electronic expression of the signage message to a memory device for display on an electronic image display screen in the signage device.

8. The method as recited in claim 6, wherein the step (b) comprises the step of providing a an endless loop signage panel bearing a plurality of signage messages for disposing around opposing rollers for rotation to display the signage messages selectively.

9. The method as recited in claim 6, wherein the step (b) comprises the step of providing a plurality of sign panels for attaching to separate signage assemblies, the plurality of sign panels bearing a complete signage message for display and the signage assemblies operatively linked so that the sign panels for a signage message are displayed for viewing simultaneously.

10. The method as recited in claim 6, further comprising the step of tracking and reporting the display of the signage messages.
